(19) United States
(12) Patent Application Publication
(10) Pub. No.: US 2020/0206811 A1
(43) Pub. Date: Jul. 2, 2020

(54) SHAPING MATERIAL FOR THREE-DIMENSIONAL SHAPED ARTICLE

(71) Applicant: SEIKO EPSON CORPORATION, Tokyo (JP)

(72) Inventor: Naoko SHIMA, Shiojiri-shi (JP)

(73) Assignee: SEIKO EPSON CORPORATION, Tokyo (JP)

(21) Appl. No.: 16/722,504

(22) Filed: Dec. 20, 2019

(30) Foreign Application Priority Data
Dec. 27, 2018 (JP) 2018-245344

(51) Int. Cl. B22F 1/00; B22F 5/00; B22F 7/02; B33Y 30/00; B22F 7/04

(52) U.S. Cl. CPC B22F 1/0059; B22F 5/00; B22F 1/0014; B22F 2007/042; B22F 2302/25; B33Y 30/00; B22F 2302/45; B22F 7/02

(57) ABSTRACT

A shaping material for a three-dimensional shaped article contains a metal powder, a cyclic cellulose derivative, a layered silicate configured to form a card-house structure, and a solvent. By forming a shaping material for a three-dimensional shaped article having such a configuration, in the shaping material for a three-dimensional shaped article containing the metal powder and the solvent, the metal powder can be prevented from precipitating in the solvent over a long period of time.

The present application is based on, and claims priority from JP Application Serial Number 2018-245344, filed on Dec. 27, 2018, the disclosure of which is hereby incorporated by reference herein in its entirety.

### BACKGROUND

### 1. Technical Field

The present disclosure relates to a shaping material for a three-dimensional shaped article.

### 2. Related Art

Heretofore, various three-dimensional shaped article production apparatuses have been used. Among these, there is a three-dimensional shaped article production apparatus producing a three-dimensional shaped article by stacking layers. As a shaping material for a three-dimensional shaped article in such a three-dimensional shaped article production apparatus, a shaping material for a three-dimensional shaped article containing a metal powder and a solvent is sometimes used. For example, JP-A-2008-184622 (Patent Document 1) discloses a three-dimensional shaped article production apparatus for producing a three-dimensional shaped article using a metal paste containing a metal powder and a solvent.

However, in a shaping material for a three-dimensional shaped article containing a metal powder and a solvent, because the metal powder has a larger specific gravity than the solvent, the metal powder sometimes precipitated in the solvent. Also in the metal paste described in Patent Document 1, the metal powder may precipitate in the solvent.

### SUMMARY

A shaping material for a three-dimensional shaped article according to an aspect of the present disclosure for solving the above problem contains a metal powder, a cyclic cellulose derivative, a layered silicate configured to form a card-house structure, and a solvent.

### BRIEF DESCRIPTION OF THE DRAWINGS

FIG. 1 is a schematic configuration view showing an example of a three-dimensional shaped article production apparatus that can use a shaping material for a three-dimensional shaped article of the present disclosure.

FIG. 2 is a graph showing flow curves of viscosity versus shear rate in Example and Comparative Examples of shaping materials for a three-dimensional shaped article of the present disclosure.

### DESCRIPTION OF EXEMPLARY EMBODIMENTS

First, the present disclosure will be schematically described.

A shaping material for a three-dimensional shaped article of a first aspect of the present disclosure for solving the above problem contains a metal powder, a cyclic cellulose derivative, a layered silicate configured to form a card-house structure, and a solvent.

According to this aspect, a cyclic cellulose derivative and a layered silicate configured to form a card-house structure are contained. By containing the layered silicate configured to form a card-house structure, the metal powder enters voids in the card-house structure, and therefore, the metal powder can be prevented from precipitating in the solvent. In general, the card-house structure is sometimes disrupted by vibration, however, by containing the cyclic cellulose derivative, disruption of the card-house structure can be suppressed by the cyclic cellulose derivative. Accordingly, the metal powder can be prevented from precipitating in the solvent over a long period of time.

In the shaping material for a three-dimensional shaped article of a second aspect of the present disclosure, in the first aspect, the layered silicate is a smectite.

According to this aspect, the layered silicate is a smectite. By using a smectite as the layered silicate, a favorable card-house structure can be formed.

In the shaping material for a three-dimensional shaped article of a third aspect of the present disclosure, in the first or second aspect, the layered silicate contains at least one of montmorillonite and hectorite.

According to this aspect, the layered silicate contains at least one of montmorillonite and hectorite. By using montmorillonite and hectorite in the layered silicate, a favorable card-house structure can be formed.

In the shaping material for a three-dimensional shaped article of a fourth aspect of the present disclosure, in any one of the first to third aspects, the cyclic cellulose derivative is β-cyclodextrin.

According to this aspect, the cyclic cellulose derivative is β-cyclodextrin. By using β-cyclodextrin as the cyclic cellulose derivative, the card-house structure of the layered silicate can be favorably protected.

In the shaping material for a three-dimensional shaped article of a fifth aspect of the present disclosure, in any one of the first to fourth aspects, the solvent contains propylene glycol.

According to this aspect, the solvent contains propylene glycol. Propylene glycol is well compatible with the cyclic cellulose derivative, and therefore can favorably dissolve the cyclic cellulose derivative.

In the shaping material for a three-dimensional shaped article of a sixth aspect of the present disclosure, in any one of the first to fifth aspects, the metal powder is contained in an amount of 90 vol % or less, and the cyclic cellulose derivative and the layered silicate are contained in an amount of 0.039 vol % or more and 4 vol % or less in total.

This is because according to this aspect, the content ratio of the metal powder and the content ratio of the cyclic cellulose derivative and the layered silicate become favorable, and therefore, the metal powder can be favorably prevented from precipitating in the solvent over a long period of time, and also the purity of the metal in the three-dimensional shaped article can be increased.

In the shaping material for a three-dimensional shaped article of a seventh aspect of the present disclosure, in the sixth aspect, the cyclic cellulose derivative and the layered silicate are contained in an amount of 0.16 vol % or more and 0.8 vol % or less in total.

This is because according to this aspect, the content ratio of the cyclic cellulose derivative and the layered silicate becomes particularly favorable, and therefore, the metal powder can be particularly favorably prevented from precipitating in the solvent over a long period of time, and also the purity of the metal in the three-dimensional shaped article can be particularly favorably increased.

In the shaping material for a three-dimensional shaped article of an eighth aspect of the present disclosure, in the sixth or seventh aspect, the layered silicate is contained in an amount of 0.026 vol % or more.

According to this aspect, the content of the layered silicate becomes favorable, and therefore, the card-house structure can be favorably formed.

In the shaping material for a three-dimensional shaped article of a ninth aspect of the present disclosure, in any one of the sixth to eighth aspects, the cyclic cellulose derivative is contained in an amount of 0.013 vol % or more.

This is because according to this aspect, the content of the cyclic cellulose derivative becomes favorable, and therefore, the card-house structure can be favorably reinforced.

In the shaping material for a three-dimensional shaped article of a tenth aspect of the present disclosure, in any one of the first to ninth aspects, a D50 as a particle diameter of the metal powder is 10 μm or less.

A three-dimensional shaped article with high precision can be formed by forming a three-dimensional shaped article using a metal powder having a small particle diameter, however, according to this aspect, the metal powder having a particle diameter of 10 μm or less is used, and therefore, a three-dimensional shaped article with high precision can be formed.

Hereinafter, embodiments according to the present disclosure will be described with reference to the accompanying drawings.

### Three-Dimensional Shaped Article Production Apparatus

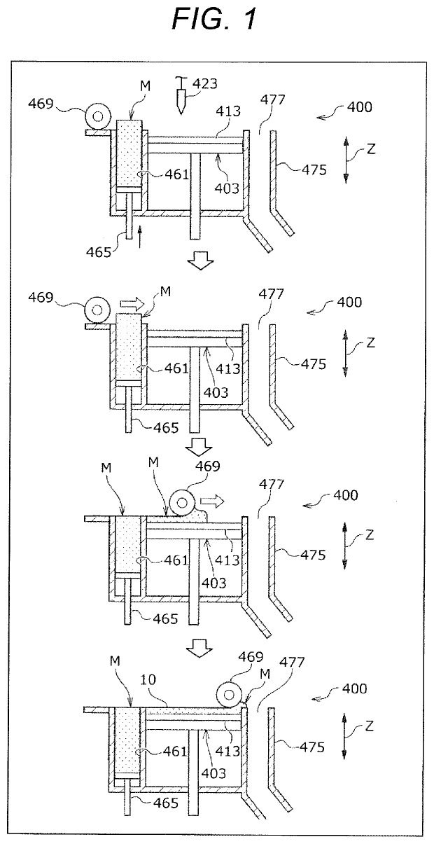

First, an outline of a three-dimensional shaped article production apparatus 400 that can use a shaping material for a three-dimensional shaped article of the present disclosure will be described with reference to FIG. 1. In FIG. 1, four state diagrams are shown for understanding the operation of the three-dimensional shaped article production apparatus 400. Note that the Z direction in the drawing is the vertical direction.

The three-dimensional shaped article production apparatus 400 shown in FIG. 1 includes a cylinder chamber 461 housing a shaping material M with fluidity at a side of a stage 403, and the cylinder chamber 461 includes a piston 465 that can be lifted and lowered in the Z direction. Although a detailed description will be given later, in the shaping material M, a metal powder, a cyclic cellulose derivative, a layered silicate configured to form a card-house structure, and a solvent are contained.

As shown in the uppermost state diagram in FIG. 1, at an upper-left side of the cylinder chamber 461 in FIG. 1, a coating roller 469 for forming a coating film having a predetermined thickness by supplying the shaping material M onto a layer forming region 413 on the stage 403 or a formed layer 10 is disposed. The coating roller 469 is configured to be able to move within a range from a position shown in the uppermost state diagram in FIG. 1 and the second state diagram from the top in FIG. 1 to a position facing a collection port 477 at an upper side of a collection chute 475 at a right side in FIG. 1 through the layer forming region 413 on the stage 403 as shown in the third state diagram from the top in FIG. 1 and the lowermost state diagram in FIG. 1.

Further, although not shown in FIG. 1 except for the uppermost state diagram in FIG. 11, the three-dimensional shaped article production apparatus 400 includes a galvo laser 423 and is configured to be able to irradiate the layer 10 formed in the layer forming region 413 with a laser. The galvo laser 423 includes a laser irradiation portion, a plurality of mirrors positioning a laser from the laser irradiation portion, and a lens converging the laser, and is configured to be able to scan the laser at a high speed in a wide range.

Here, a flow of the production of a three-dimensional shaped article by the three-dimensional shaped article production apparatus 400 will be described.

When a three-dimensional shaped article is produced using the three-dimensional shaped article production apparatus 400, operations are allowed to proceed in the order of preparation of the shaping material M, coating with the shaping material M, and melting of the shaping material M. Hereinafter, contents of these operations will be described.

First, in the preparation of a composition with fluidity, a necessary amount of the shaping material M is filled in the cylinder chamber 461. Subsequently, as shown in the uppermost state diagram in FIG. 1 and the second state diagram from the top in FIG. 1, the piston 465 is moved to an upper side by a predetermined amount necessary for forming the layer 10 for one layer. Further, the stage 403 is previously set at a predetermined height when the layer 10 for one layer is formed, and the coating roller 469 is previously placed at a position shown in the uppermost state diagram in FIG. 1 and the second state diagram from the top in FIG. 1.

Subsequently, in the coating with the shaping material M, the coating roller 469 is moved from the position shown in the uppermost state diagram in FIG. 1 and the second state diagram from the top in FIG. 1 to the stage 403 side as shown in the third state diagram from the top in FIG. 1. At this time, the coating roller 469 is brought onto the stage 403 so as to scrape up the shaping material M in a region projecting from the upper face of the cylinder chamber 461, and fill the shaping material M on the stage 403 as shown in the third state diagram from the top in FIG. 1 and the lowermost state diagram in FIG. 1. The coating roller 469 moves to the position facing the collection port 477 at an upper side of the collection chute 475 at a right side in FIG. 1 of the layer forming region 413 on the stage 403 and discharges the excess shaping material M to the collection chute 475.

Subsequently, in the melting of the shaping material M, the coating roller 469 is retracted to the position shown in the uppermost state diagram in FIG. 1 and the second state diagram from the top in FIG. 1 from the position on the layer forming region 413, and the shaping material M in a region corresponding to the three-dimensional shaped article in the layer 10 is melted using the galvo laser 423.

Then, the layers 10 constituted by performing the preparation of the shaping material M, the coating with the shaping material M, and the melting of the shaping material M are stacked, whereby a desired three-dimensional shaped article is produced.

The three-dimensional shaped article production apparatus that can use the shaping material M for a three-dimensional shaped article of the present disclosure is not limited to apparatuses of a powder bed fusion type such as the three-dimensional shaped article production apparatus 400. For example, an apparatus forming the layer 10 using a dispenser ejecting the shaping material M or the like can also be used. A desired three-dimensional shaped article may be produced by forming the layers 10 using a dispenser, and stacking the layers 10 constituted by performing the melting of the shaping material M.

### Shaping Material for Three-Dimensional Shaped Article

Next, the shaping material M for a three-dimensional shaped article will be described in detail.

The shaping material M for a three-dimensional shaped article of the present disclosure contains a metal powder, a cyclic cellulose derivative, a layered silicate configured to form a card-house structure, and a solvent. By containing the layered silicate configured to form a card-house structure in this manner, layered crystals form a three-dimensional mesh-like structure, and the metal powder enters between the layers in the structure, whereby the metal powder can be prevented from precipitating in the solvent. In general, the card-house structure is sometimes disrupted by vibration, however, by containing the cyclic cellulose derivative, disruption of the card-house structure can be suppressed by the cyclic cellulose derivative. Accordingly, by forming the shaping material M having such a configuration, the metal powder can be prevented from precipitating in the solvent for a long period of time. The card-house structure is a three-dimensional network structure in which layered microcrystals form a three-dimensional mesh-like structure.

### Layered Silicate

The layered silicate contained in the shaping material M is not particularly limited as long as it can form a card-house structure, however, a smectite can be favorably used. This is because by using a smectite as the layered silicate, a favorable card-house structure can be formed. As the smectite, montmorillonite, hectorite, beidellite, nontronite, saponite, sauconite, volkonskoite, swinefordite, stevensite, or the like can be used.

Further, particularly, montmorillonite and hectorite can be preferably used. This is because by containing at least one of montmorillonite and hectorite as the layered silicate, a particularly favorable card-house structure can be formed.

### Cyclic Cellulose Derivative

As the cyclic cellulose derivative contained in the shaping material M, an existing cyclic cellulose derivative that can be used as a thickener or the like can be used, however, a cyclodextrin can be preferably used.

Among the cyclodextrins, β-cyclodextrin can be particularly preferably used. This is because by using β-cyclodextrin as the cyclic cellulose derivative, the card-house structure of the layered silicate can be favorably protected.

### Metal Powder

As the metal powder contained in the shaping material M, various metals such as stainless steel (SUS), aluminum, iron, and copper can be used according to the three-dimensional shaped article to be shaped without any particular limitation. Further, the particle diameter of the metal powder is also not particularly limited.

### Ceramic Powder

As the ceramic powder contained in the shaping material M, various ceramics such as alumina, silica, zirconia, beryllia, barium titanate, strontium titanate, and silicon carbide can be used according to the three-dimensional shaped article to be shaped without any particular limitation.

Further, the ceramic powder may be used by being mixed with the above-mentioned metal powder.

Further, examples of a powder of an accessory component include elements for alloying such as graphite, Ni, Cu, Cr, Mn, Si, Mo, P, S, and Nb, and these may be used alone or two or more of these may be used in combination.

The mixing ratio of the metal powder as the main component to the powder of the accessory component is preferably 90 to 99.8%/0.2 to 10%, more preferably 93 to 99.5%/0.5 to 7%.

However, as for the particle diameter of the metal powder, a metal powder having a D50 of 10 μm or less can be preferably used. This is because although a three-dimensional shaped article with high precision can be formed by forming a three-dimensional shaped article using a metal powder having a small particle diameter, by using a metal powder having a D50 of 10 μm or less, a three-dimensional shaped article with high precision can be formed.

### Solvent

As the solvent contained in the shaping material M, water or various organic solvents can be freely combined and used without any particular limitation. However, the solvent preferably contains propylene glycol. This is because propylene glycol is well compatible with the cyclic cellulose derivative, and therefore can favorably dissolve the cyclic cellulose derivative.

### Another Constituent Component

The shaping material M can contain, other than the metal powder, the cyclic cellulose derivative, the layered silicate configured to form a card-house structure and the solvent, another constituent component, for example, a preservative or the like according to need.

### Preferred Contents of Respective Constituent Components

As preferred contents of the respective constituent components of the shaping material M, 90 vol % or less of the metal powder, and 0.039 vol % or more and 4 vol % or less in total of the cyclic cellulose derivative and the layered silicate are exemplified. This is because by setting the contents of the respective constituent components of the shaping material M within such ranges, the content ratio of the metal powder and the content ratio of the cyclic cellulose derivative and the layered silicate become favorable. Specifically, by setting the sum of the contents of the cyclic cellulose derivative and the layered silicate to 0.039 vol % or more, the metal powder can be favorably prevented from precipitating in the solvent over a long period of time, and by setting the sum of the contents of the cyclic cellulose derivative and the layered silicate to 4 vol % or less, a too much amount of components other than the metal can be prevented from remaining in the three-dimensional shaped article.

Further, particularly, it is preferred to set the sum of the contents of the cyclic cellulose derivative and the layered silicate to 0.16 vol % or more and 0.8 vol % or less. This is because the content ratio of the cyclic cellulose derivative and the layered silicate becomes particularly favorable, and therefore, the metal powder can be particularly favorably prevented from precipitating in the solvent over a long period of time, and also a too much amount of components other than the metal can be particularly favorably prevented from remaining in the three-dimensional shaped article.

Further, it is preferred to contain the layered silicate in an amount of 0.026 vol % or more. This is because the content of the layered silicate becomes favorable, and therefore, the card-house structure can be favorably formed.

Further, it is preferred to contain the cyclic cellulose derivative in an amount of 0.013 vol % or more. This is because the content of the cyclic cellulose derivative becomes favorable, and therefore, the card-house structure can be favorably reinforced.

### Examples of Shaping Material M

Next, Examples of the specific shaping material M will be described.

A shaping material M1 of Example 1, a shaping material M2 of Example 2, a shaping material M3 of Example 3, a shaping material M4 of Example 4, a shaping material MA of Comparative Example 1, and a shaping material MB of Comparative Example 2, each containing the following components were prepared. Here, numerical values are shown by rounding some numbers after the decimal point. Note that the following Sumecton-SWN is a smectite, and in detail, corresponds to hectorite among smectites.

### Example 1: Shaping Material M1

PF-5F (manufactured by Epson Atmix Corporation) that is SUS as the metal powder: 87 vol %

β-cyclodextrin as the cyclic cellulose derivative: 0.0978 vol %

Sumecton-SWN (Kunimine Industries Co., Ltd.) as the layered silicate: 0.0652 vol %

propylene glycol as the solvent: 9.68 vol %

water as the solvent: 3.19 vol %

Here, the sum of the contents of the cyclic cellulose derivative and the layered silicate in the shaping material M1 of Example 1 is 0.163 vol %.

### Example 2: Shaping Material M2

The shaping material M2 is a shaping material in which with respect to the shaping material M1 of Example 1, the content of Sumecton-SWN was reduced to 0.0261 vol %, and the reduced amount of Sumecton-SWN was replaced with the solvent.

### Example 3: Shaping Material M3

The shaping material M3 is a shaping material in which with respect to the shaping material M1 of Example 1, the content of β-cyclodextrin was reduced to 0.0130 vol %, and the reduced amount of β-cyclodextrin was replaced with the solvent.

### Example 4: Shaping Material M4

The shaping material M4 is a shaping material in which with respect to the shaping material M1 of Example 1, the content of β-cyclodextrin and Sumecton-SWN was reduced to 0.039 vol %, and the reduced amount of β-cyclodextrin and Sumecton-SWN was replaced with the solvent.

### Comparative Example 1: Shaping Material MA

The shaping material MA is a shaping material in which with respect to the shaping material M1 of Example 1, the content of β-cyclodextrin and Sumecton-SWN was reduced to 0, and the reduced amount of β-cyclodextrin and Sumecton-SWN was replaced with the solvent.

That is, in the shaping material MA of Comparative Example 1, the cyclic cellulose derivative and the layered silicate are not contained.

### Comparative Example 2: Shaping Material MB

The shaping material MB is a shaping material in which with respect to the shaping material M1l of Example 1, the content of β-cyclodextrin was reduced to 0, and the reduced amount of β-cyclodextrin was replaced with the solvent.

That is, in the shaping material MB of Comparative Example 2, the cyclic cellulose derivative is not contained.

### Evaluation of Structural Viscosity and Evaluation of Precipitation

With respect to the shaping material M1 of Example 1, the shaping material M2 of Example 2, the shaping material M3 of Example 3, the shaping material M4 of Example 4, the shaping material MA of Comparative Example 1, and the shaping material MB of Comparative Example 2 described above, evaluation of structural viscosity and evaluation of precipitation were performed. The evaluation of structural viscosity was performed based on whether or not the viscosity decreased when the shear rate was increased, and the evaluation of precipitation was performed based on whether or not solid-liquid separation occurred when each shaping material M was placed in a vessel and left to stand.

As a result, the shaping material M1 of Example 1 has a sufficient structural viscosity and precipitation did not occur for a long period of time. Further, the shaping material M2 of Example 2 and the shaping material M3 of Example 3 also have a sufficient structural viscosity, though not to the extent of the shaping material M1 of Example 1, and precipitation did not occur for a long period of time. The shaping material M4 of Example 4 has a bare structural viscosity, and precipitation was suppressed as compared with the shaping material MA of Comparative Example 1. Further, in the shaping material MB of Comparative Example 2, solid-liquid separation, for which vibration is thought to be the reason, occurred in the evaluation of precipitation. Further, also when alumina was used as the ceramic powder in place of PF-5F (manufactured by Epson Atmix Corporation) that is SUS as the metal powder: 87 vol %, the same effect was obtained.

### Flow Curve of Viscosity Versus Shear Rate

### Example 5: Shaping Material M5, Comparative Example 3: Shaping Material MC, and Comparative Example 4: Shaping Material MD

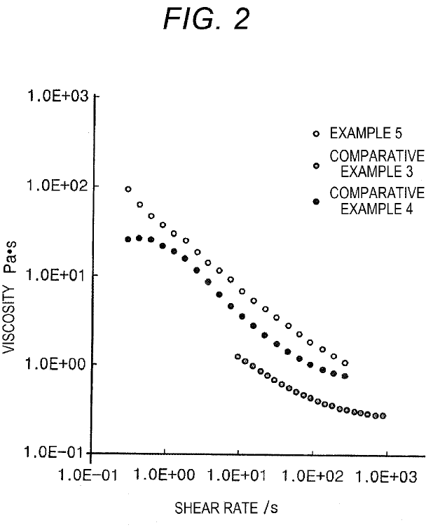

FIG. 2 shows flow curves of viscosity versus shear rate of a shaping material M5 of Example 5, a shaping material MC of Comparative Example 3, and a shaping material MD of Comparative Example 4. Here, the shaping material M5 of Example 5 has a similar composition to that of the shaping material M1 of Example 1 such that Admanano YA010C-SV1 (manufactured by Admatechs Co., Ltd.) that is silicon particles not forming a card-house structure is contained in the shaping material M1, and so on. Further, the shaping material MC of Comparative Example 3 has a similar composition to that of the shaping material MA of Comparative Example 1 such that Admanano YA010C-SV1 is contained in the shaping material MA, and so on. Then, the shaping material MD of Comparative Example 4 has a similar composition to that of the shaping material MA of Comparative Example 1 such that β-cyclodextrin and Admanano YA010C-SV1 are contained in the shaping material MA, and so on.

As shown in FIG. 2, the shaping material M5 of Example 5 has a yield value corresponding to a force necessary for making a fluid in a standing state flow, and the viscosity in a state where the shear rate is low that is close to a standing state or the like is particularly high. That is, the shaping material M5 of Example 5 has a composition capable of effectively suppressing precipitation of SUS as the metal powder in a standing state. On the other hand, in the shaping material MC of Comparative Example 3, although the presence or absence of a yield value was not measured, the viscosity thereof is low in the first place, and suppression of precipitation of SUS in a standing state is insufficient. Then, the shaping material MD of Comparative Example 4 does not have a yield value, and suppression of precipitation of SUS in a standing state is insufficient.

What is claimed is:

1. A shaping material for a three-dimensional shaped article, comprising:
a metal powder;
a cyclic cellulose derivative;
a layered silicate configured to form a card-house structure; and
a solvent.

2. The shaping material for a three-dimensional shaped article according to claim 1, wherein the layered silicate is a smectite.

3. The shaping material for a three-dimensional shaped article according to claim 1, wherein the layered silicate contains at least one of montmorillonite and hectorite.

4. The shaping material for a three-dimensional shaped article according to claim 1, wherein the cyclic cellulose derivative is β-cyclodextrin.

5. The shaping material for a three-dimensional shaped article according to claim 1, wherein the solvent contains propylene glycol.

6. The shaping material for a three-dimensional shaped article according to claim 1, wherein the metal powder is contained in an amount of 90 vol % or less, and the cyclic cellulose derivative and the layered silicate are contained in an amount of 0.039 vol % or more and 4 vol % or less in total.

7. The shaping material for a three-dimensional shaped article according to claim 6, wherein the cyclic cellulose derivative and the layered silicate are contained in an amount of 0.16 vol % or more and 0.8 vol % or less in total.

8. The shaping material for a three-dimensional shaped article according to claim 6, wherein the layered silicate is contained in an amount of 0.026 vol % or more.

9. The shaping material for a three-dimensional shaped article according to claim 6, wherein the cyclic cellulose derivative is contained in an amount of 0.013 vol % or more.

10. The shaping material for a three-dimensional shaped article according to claim 1, wherein a D50 as a particle diameter of the metal powder is 10 μm or less.
